(19) United States
(12) Patent Application Publication
(10) Pub. No.: US 2025/0343366 A1
(43) Pub. Date: Nov. 6, 2025

(54) COUPLER FOR CONNECTING DUCTILE CONDUCTORS

(71) Applicant: Caterpillar Inc., Peoria, IL (US)

(72) Inventors: Matthew J. Rettick, Bloomington, IL (US); Andrew M. Moruzi, Washington, IL (US); Steven D. Wetherell, East Peoria, IL (US); Trevor J. Smith, Peoria Heights, IL (US)

(73) Assignee: Caterpillar Inc., Peoria, IL (US)

(21) Appl. No.: 18/655,634

(22) Filed: May 6, 2024

(51) Int. Cl. H01R 4/38

(52) U.S. Cl. CPC H01R 4/38

(57) ABSTRACT

A coupler for electrically connecting a first conductor to a second conductor includes a clip and a fastening system. The clip defines a first clip segment and a second clip segment. The segments are configured to respectively abut with the conductors to accommodate overlapped portions of the conductors therebetween. The fastening system is engageable with the segments such that an actuation of the fastening system reduces a gap between the segments to increase a compression and contact between the conductors. Compared to surface areas of the fastening system, the segments define relatively larger corresponding surface areas for respectively contacting the conductors and providing commensurate compression therebetween.

### TECHNICAL FIELD

The present disclosure relates to a coupler for electrically connecting conductors, e.g., copper busbars, to each other. More particularly, the present disclosure relates to a coupler that increases an electrical contact area between the conductors for enhancing electrical connectivity therebetween.

### BACKGROUND

Electrical conductors are commonly applied in the electric power industry to connect electrical devices such as electric power sources and/or electrical loads (e.g., generator sets) to each other and/or to one or more other electrical equipment. Generally, conductors include conducting bars (e.g., copper busbars) which may be capable of conducting and transmitting relatively large amounts of electric current therethrough. In application, surfaces of such conductors may be abutted and joined to each other by use of a coupler or a clamp system for attaining electrical contact and flow therebetween.

A quality of an electrical contact between the conductors for enabling an electrical flow to pass through may depend upon a clamp force imparted by the clamp system. An improper electrical contact between the conductors may affect a clearance value and creepage between the conductors, resulting in a relatively large joint resistance between the conductors along with an impediment to the electrical flow. Some conductors, such as copper conductors or busbars, may exhibit properties, such as ductility, that may hinder any commensurate improvement in the electrical contact with any increase in the clamp force.

United States Publication No.: 20220173556 relates to a bus bar that includes a main body having a plate shape for arranging a terminal to be electrically connected to the bus bar and an upright provided at a side in a widthwise direction of the main body. The main body has an open hole into which a shaft of a bolt is to be inserted. The upright has an inner surface with which a head of the bolt can come into contact in a rotational direction.

### SUMMARY OF THE INVENTION

In one aspect, the disclosure is directed to a coupler for electrically connecting a first conductor to a second conductor. The coupler includes a clip and a fastening system. The clip defines a first clip segment and a second clip segment spaced apart from the first clip segment. The first clip segment and the second clip segment are configured to respectively abut with the first conductor and the second conductor to accommodate overlapped portions of the first conductor and the second conductor therebetween. The fastening system is engageable with the first clip segment and the second clip segment such that an actuation of the fastening system reduces a gap between the first clip segment and the second clip segment to increase a compression and contact between the first conductor and the second conductor. Compared to surface areas of the fastening system, the first clip segment and the second clip segment define relatively larger corresponding surface areas for respectively contacting the first conductor and the second conductor and providing commensurate compression therebetween.

In another aspect, the disclosure relates to an electrical system. The electrical system includes a first electrical device and a second electrical device. Further, the electrical system includes a first conductor operatively extending from the first electrical device and a second conductor operatively extending from the second electrical device. Also, the electrical system includes a coupler for electrically connecting the first conductor to the second conductor. The coupler includes a clip defining a first clip segment and a second clip segment spaced apart from the first clip segment. The first clip segment and the second clip segment are respectively abutted with the first conductor and the second conductor to accommodate overlapped portions of the first conductor and the second conductor therebetween. The coupler also includes a fastening system engageable with the first clip segment and the second clip segment such that an actuation of the fastening system reduces a gap between the first clip segment and the second clip segment to increase a compression and contact between the first conductor and the second conductor. Compared to surface areas of the fastening system, the first clip segment and the second clip segment define relatively larger corresponding surface areas for respectively contacting the first conductor and the second conductor and providing commensurate compression therebetween.

### BRIEF DESCRIPTION OF THE DRAWINGS

FIG. 1 is a schematic view of an electrical system having a first conductor and a second conductor, in accordance with an embodiment of the present disclosure;

FIG. 2 is a perspective top view of overlapped portions of the first conductor and the second conductor, in accordance with an embodiment of the present disclosure;

FIG. 3 is a perspective bottom view of overlapped portions of the first conductor and the second conductor, in accordance with an embodiment of the present disclosure;

FIG. 4 is an exploded view of a coupler for electrically connecting the first conductor to the second conductor, in accordance with an embodiment of the present disclosure; and

FIGS. 5 and 6 are various views of the coupler in application with respect to the overlapped portions, in accordance with an embodiment of the present disclosure.

### DETAILED DESCRIPTION

Reference will now be made in detail to specific embodiments or features, examples of which are illustrated in the accompanying drawings. Generally, corresponding reference numbers may be used throughout the drawings to refer to the same or corresponding parts, e.g., 1, 1′, 1″, 101 and 201 could refer to one or more comparable components used in the same and/or different depicted embodiments.

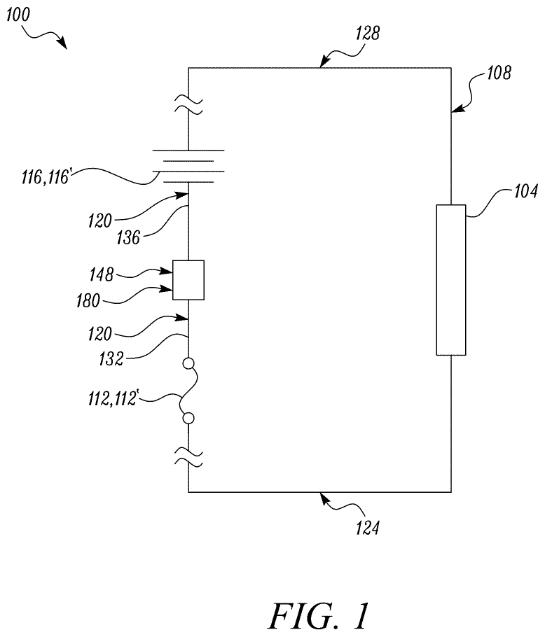

Referring to FIG. 1, an electrical system 100 is described. The electrical system 100 may include a load 104. Further, the electrical system 100 may include various electrical devices, such as fuses, batteries, switches, safety disconnect units, and the like devices, that may in concert be applied to serve the load. One or more electrical devices of the electrical system 100 may be electrically connected to one or more other electrical devices of the electrical system 100. For this purpose, the electrical system 100 may also include several electrical lines (e.g., formed by using one or more conductors) that may extend between those electrical devices. Such electrical lines may extend between the electrical devices and the load, e.g., to form an electrical circuit 108 of the electrical system 100.

As an example, FIG. 1 illustrates two electrical devices, namely, a first electrical device 112 (e.g., a fuse 112′) and a second electrical device 116 (e.g., a battery 116′), electrically connected to each other through a first electrical line 120. Further, FIG. 1 exemplarily illustrates a second electrical line 124 extending between the first electrical device 112 and the load 104 and a third electrical line 128 extending between the second electrical device 116 and the load 104. Various other devices may be provided on or along the second electrical line 124 and/or the third electrical line 128, but they are not discussed for brevity.

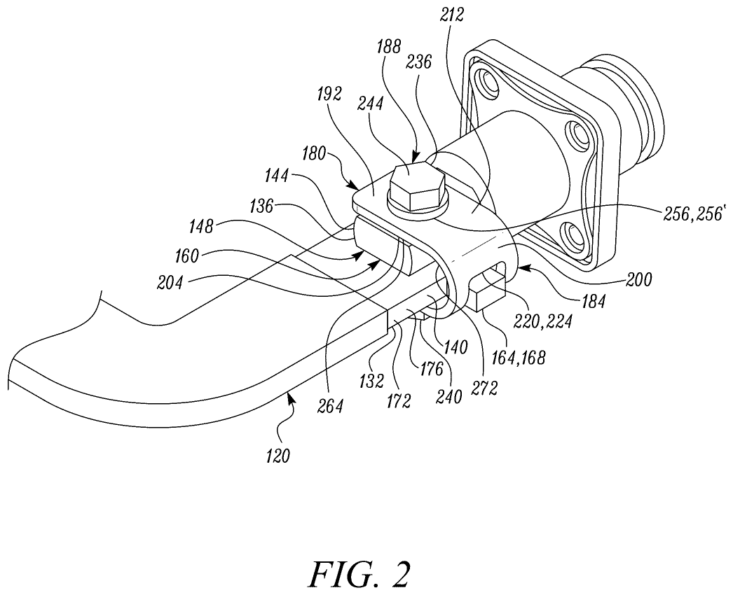

Referring to FIGS. 2 through 6, the first electrical line 120 (or simply, the electrical line 120 hereinafter) may exemplarily include or be formed, at least in part, by a first conductor 132 and a second conductor 136. The first conductor 132 may operatively extend from the first electrical device 112 and the second conductor 136 may operatively extend from the second electrical device 116. For an electrical connection to be defined or established between the first conductor 132 and the second conductor 136 and/or for the formation of the electrical line 120, a portion (e.g., a first end portion 140) of the first conductor 132 may be overlapped with a portion (e.g., a second end portion 144) of the second conductor 136 and may joined to each other at an electrical joint 148. Although not limited, at least one (or one or more parts, correspondingly) of the first conductor 132 and/or the second conductor 136 may be made from copper and/or include or correspond to a copper busbar. Further, the first conductor 132 may define a first opening 152 in the first end portion 140 and the second conductor 136 may define a second opening 156 in the second end portion 144.

The term “overlapped” may mean or correspond to bringing forth said portions (e.g., the first end portion 140 and the second end portion 144) of the first conductor 132 and the second conductor 136 and placing them one over or on top of the other such that the portions (e.g., the first end portion 140 and the second end portion 144) are abutted and/or set in contact (e.g., physical contact) with each other. Portions (e.g., the first end portion 140 and the second end portion 144) of the first conductor 132 and the second conductor 136 overlapped with each other in such a manner may be referred to as “overlapped portions 160” and a corresponding condition of the first conductor 132 and the second conductor 136 may be referred to as an “overlapped condition”. In the overlapped condition, the first opening 152 of the first end portion 140 may be aligned or fall in line with the second opening 156 of the second end portion 144.

Once the abutment or contact between the portions (e.g., the first end portion 140 and the second end portion 144) of the first conductor 132 and the second conductor 136 is attained to establish the overlapped portions 160 or to arrive at the overlapped condition, the portions (e.g., the first end portion 140 and the second end portion 144) may be pressed against each other such that a physical contact of the first end portion 140 of the first conductor 132 can be increased or improved with respect to the second end portion 144 of the second conductor 136 to enhance electrical conductivity therethrough. In that manner, the electrical line 120 extending between the first electrical device 112 and the second electrical device 116 may be formed or established. An exemplary manner in which such improved physical contact may be attained between the first end portion 140 and the second end portion 144 will be discussed further below.

Although not limited, each of the first conductor 132 and the second conductor 136 may include a cross-section (e.g., a rectangular cross-section or an oblong cross-section) and their portions (e.g., the first end portion 140 and the second end portion 144) may define flat surfaces that can come into contact with each other in the overlapped condition at the electrical joint 148. Further, according to some embodiments, at least one of the first conductor 132 and the second conductor 136 may define an engagement feature 164. As an example, the engagement feature 164 may be provided on the first conductor 132. Further, as an example, the engagement feature 164 may include a protrusion 168 extending from a body 172 of the first conductor 132. The protrusion 168 may extend outwardly (e.g., laterally outwardly) from a surface (e.g., from a side surface 176) of the body 172 of the first conductor 132.

The electrical system 100 may also include a coupler 180 for electrically connecting the first conductor 132 to the second conductor 136 such that the first electrical device 112 may be operably (or electrically) connected with the second electrical device 116. To attain the electrical connection between the first conductor 132 and the second conductor 136 and/or form the electrical line 120, the coupler 180 may be positioned at the overlapped portions 160 and may be mechanically engaged (in a manner as will be exemplarily described below) with the overlapped portions 160, such that the electrical connection can be attained between the first conductor 132 and the second conductor 136. The coupler 180 includes a clip 184 and a fastening system 188, details related to each of which shall now be discussed.

The clip 184 may include a first clip segment 192 and a second clip segment 196. The second clip segment 196 may be spaced apart from the first clip segment 192 and may accordingly define a space, S, therebetween. Further, the clip 184 may include a connector segment 200 extending between the first clip segment 192 and the second clip segment 196. In one example, the connector segment 200 may extend between ends of the first clip segment 192 and the second clip segment 196, such that together, the first clip segment 192, the second clip segment 196, and the connector segment 200, may define or impart a generally U-shaped profile to the clip 184, as shown. The first clip segment 192 and the second clip segment 196 may further define internal surfaces—e.g., the first clip segment 192 may define a first internal surface 204 and the second clip segment 196 may define a second internal surface 208. The first internal surface 204 and the second internal surface 208 may face or be directed towards each other. The first clip segment 192 and the second clip segment 196 may also define external surfaces—e.g., the first clip segment 192 may define a first external surface 212 and the second clip segment 196 may define a second external surface 216 that may face away from or be directed oppositely to each other. Although not limited, the first clip segment 192, the second clip segment 196, and the connector segment 200, may be all integrally and contiguously formed.

In some embodiments, the clip 184 may define a mating member 220 to complimentarily engage with the engagement feature 164 (e.g., the protrusion 168) to restrict the clip 184 within a range of motion (e.g., angular motion) (described in detail later) with respect to the first conductor 132 or the second conductor 136. To this end, the mating member 220 may include a window 224 to, at least partly, receive the protrusion 168 to enable the mating member 220 to complimentarily engage with the engagement feature 164. In some embodiments, the window 224 may be formed in the connector segment 200 that extends between the first clip segment 192 and the second clip segment 196.

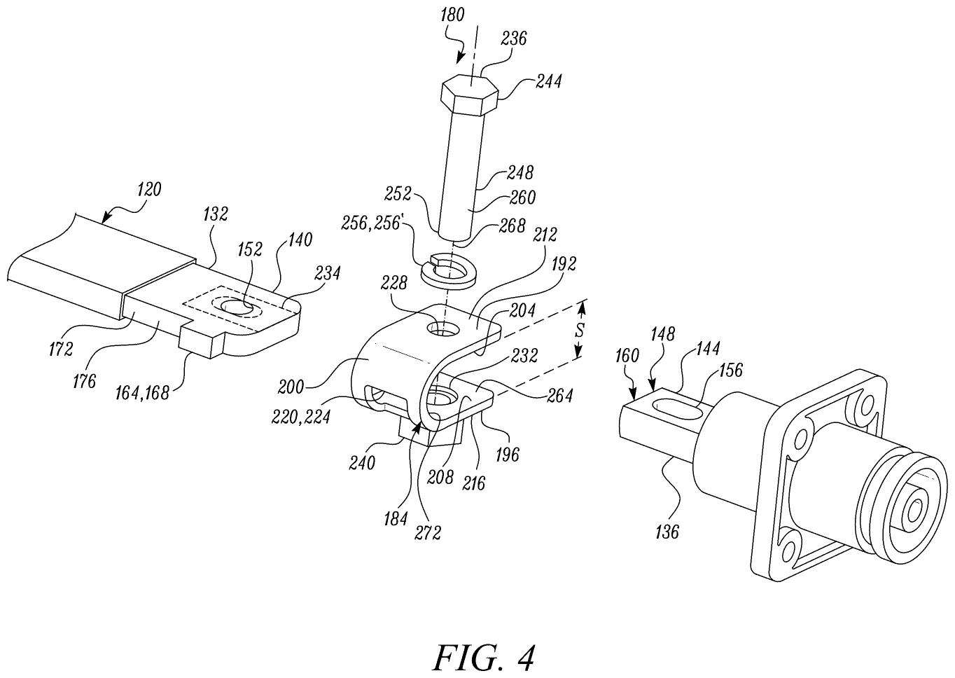

Although not limited, each of the first internal surface 204 and the second internal surface 208 may be flat inner surfaces. Further, in some embodiments, the first internal surface 204 may be parallel to the second internal surface 208, although it is possible for the first internal surface 204 and the second internal surface 208 to be disposed at an angle to each other, as well. In some embodiments, the first clip segment 192 and the second clip segment 196 may define corresponding apertures. As an example, the first clip segment 192 may define a first aperture 228 (see FIG. 4) and the second clip segment 196 may define a second aperture 232 (see FIG. 4). The first aperture 228 and the second aperture 232 may be respectively located on the first clip segment 192 and the second clip segment 196, as shown, and may be inline or co-axial to each other.

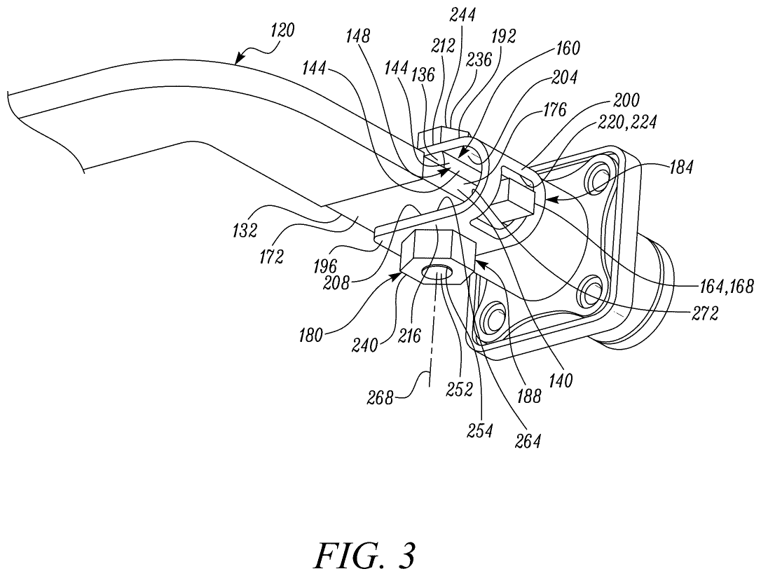

The fastening system 188 will now be discussed. The fastening system 188 may be engageable with the first clip segment 192 and the second clip segment 196 such that an actuation of the fastening system 188 may reduce a gap (or the space, S) defined between the first clip segment 192 and the second clip segment 196 to increase a compression and contact (e.g., electrical contact at an area 234 exemplarily shown in FIG. 4) between the first conductor 132 and the second conductor 136. To this end, the fastening system 188 may include a fastener, e.g., a bolt 236. The fastening system 188 may also include a nut 240. The bolt 236 may include a head portion 244 and a shank portion 248 extending from the head portion 244. In assembly, the bolt 236 (e.g., the shank portion 248 of the bolt 236) may be passed through the first aperture 228 and the second aperture 232 respectively formed in the first clip segment 192 and the second clip segment 196 such that a section of the bolt 236 (e.g., see section 252 of the shank portion 248 of the bolt 236 in FIGS. 3 and 4) may be extended outwardly of the second clip segment 196.

The nut 240 may be fixedly fastened (e.g., by welding) to the second clip segment 196 (e.g., to the second external surface 216 of the second clip segment 196) such that a hole 254 (see FIG. 3) defined by the nut 240 may be aligned with the second aperture 232 formed in the second clip segment 196. Moreover, the nut 240 may be coupled (e.g., threadably coupled) to the section 252 of the bolt 236 as the bolt 236 may extend outwardly of the second clip segment 196, during an assembly of the bolt 236 with the clip 184, in order to receive and retain the bolt 236 with the clip 184.

The coupler 180 (and/or the fastening system 188) may further include one or more washers (e.g., see washer 256). The washer 256 may be positionable between the head portion 244 and the clip 184, as shown. As an example, the washer 256 may be applied between the head portion 244 of the bolt 236 and one of the external surfaces (e.g., the first external surface 212) defined by the first clip segment 192 of the clip 184. The washer 256 may be a preload washer. More particularly, the washer 256 may be configured to exert a force between the bolt 236 and the clip 184 to apply tension therebetween and thus prevent a dislodgement of the bolt 236 with respect to the clip 184, e.g., during an assembly of the clip 184 to the overlapped portions 160 or during an operation of the electrical line 120. To this end, the washer 256 may include a split washer 256′. Other washer types may be contemplated. Further, in some embodiments, e.g., in case where the nut 240 is separate and not welded or fixedly fastened to the second clip segment 196, a similar washer may be provided between the nut 240 and the second external surface 216 of the second clip segment 196, as well.

In some embodiments, the coupler 180 (or portions or sections of the coupler 180) may define one or more surfaces that may be galvanically compatible with the overlapped portions 160 of the first conductor 132 and/or the second conductor 136 to reduce corrosion. For example, the bolt 236 may define a first outer surface 260 (see FIG. 4) configured to come in contact with the overlapped portions 160. The first outer surface 260 may include a primary material galvanically compatible with the overlapped portions 160 to reduce corrosion of the overlapped portions 160 and the bolt 236 by reducing a potential between the overlapped portions 160 and the bolt 236. Similar discussion may be applied to the clip 184 or to portions of the clip 184. For example, the clip 184 may define a second outer surface 264 configured to come in contact with the overlapped portions 160. As may be noted, the second outer surface 264 may exemplarily include, at least in part, the first internal surface 204 and the second internal surface 208 and/or also a connector internal surface 272 defined by the connector segment 200. The second outer surface 264 may include a secondary material galvanically compatible with the overlapped portions 160 to reduce corrosion of the overlapped portions 160 and the clip 184 by reducing a potential between the overlapped portions 160 and the clip 184. In some embodiments, the clip 184 may be wholly made from the secondary material. In some embodiments, one or more of the fastening system 188 and/or the clip 184 includes an insulation material (e.g., an epoxy coating) in order to be non-conductive relative to one or more of the first conductor 132 and the second conductor 136.

### INDUSTRIAL APPLICABILITY

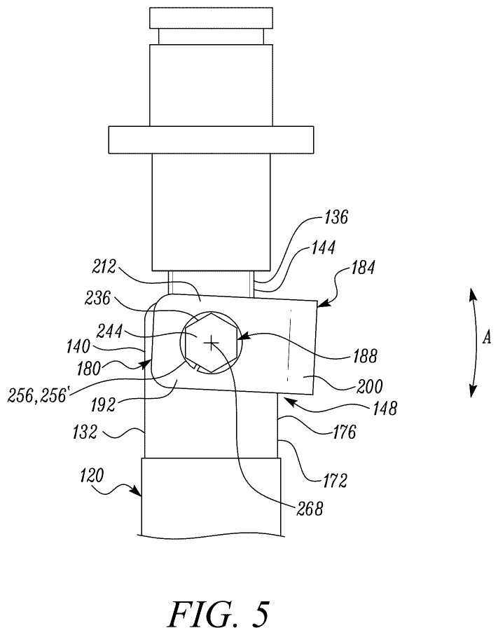

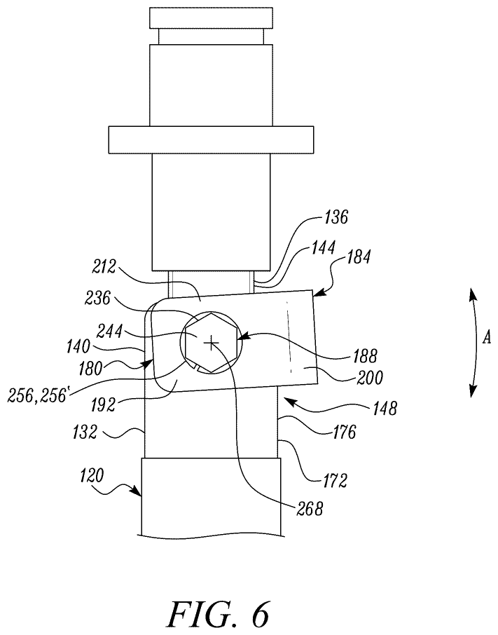

Referring to FIGS. 5 and 6, and also in conjunction with FIGS. 1 through 4, for electrically connecting the first electrical device 112 to the second electrical device 116, the coupler 180 may be assembled with the overlapped portions 160 of the first conductor 132 and the second conductor 136. For doing so, an operator may first bring forth the first conductor 132 and the second conductor 136 towards each other such that the portions (e.g., the first end portion 140 and the second end portion 144) of the first conductor 132 and the second conductor 136 can be overlapped and brought into contact with each other, thus enabling the first conductor 132 and the second conductor 136 to attain the overlapped condition. As described above, in the overlapped condition, the first opening 152 of the first conductor 132 may fall in line or align with the second opening 156 of the second conductor 136.

Once the overlapped condition is attained, the operator may slide the clip 184 over onto the overlapped portions 160 of the first conductor 132 and the second conductor 136 such that the first clip segment 192 and the second clip segment 196 can respectively abut with the first conductor 132 (e.g., the first internal surface 204 may abut with the first end portion 140 of the first conductor 132) and the second conductor 136 (e.g., the second internal surface 208 may abut with the second end portion 144 of the second conductor 136). In so doing, the first clip segment 192 and the second clip segment 196 may accommodate the overlapped portions 160 of the first conductor 132 and the second conductor 136 between them. In other words, the overlapped portions 160 of the first conductor 132 and the second conductor 136 may be inserted into the space, S, defined between the first clip segment 192 and the second clip segment 196. At this point, the operator may ensure that the first aperture 228 and the second aperture 232 may fall in line with each of the first opening 152 and the second opening 156 to define a common passage therethrough.

Additionally, at this point, the operator may ensure that the engagement feature 164 or the protrusion 168 extending from the body 172 of the first conductor 132 may be received by the mating member 220 and/or the window 224 defined by the connector segment 200 of the clip 184. In so doing, the engagement feature 164 (or protrusion 168) may be retained within the mating member 220 (or the window 224) and the clip 184 may be restricted for angular movement about an axis (e.g., bolt axis 268) of the bolt 236 within a range of motion (e.g., an angular motion) with respect to the first conductor 132 or the second conductor 136. In some embodiments, an exemplary angular range, A, (see FIGS. 5 and 6) for the angular motion may be within 0 (zero) to 10 (ten) degrees.

Once the clip 184 is positioned over the overlapped portions 160 in the aforementioned manner, the operator may access the bolt 236 of the fastening system 188 and may insert the shank portion 248 (e.g., with the washer 256 mounted therearound) into the common passage. As an example, the shank portion 248 may first enter into the first aperture 228, and thereafter sequentially into the first opening 152, second opening 156, and the second aperture 232. As the shank portion 248 (or the bolt 236) may be pushed further into the common passage, the section 252 of the bolt 236 (or the shank portion 248) may be extended into the nut 240 as the hole 254 defined by the nut 240 may be aligned with the second aperture 232 formed in the second clip segment 196. Once the shank portion 248 enters into the nut 240, the bolt 236 may be threadably tightened and coupled with respect to the nut 240, e.g., with the use of a suitable tool or a key (not shown). The nut 240 being fixedly fastened (e.g., by welding) to the second clip segment 196 negates any additional tool needed to handle the nut 240 and which may be particularly helpful if access to the nut 240, during the assembly, is spatially constrained. Effectively, the bolt 236 may be routed through the overlapped portions 160 of the first conductor 132 and the second conductor 136, as well.

At this point, the bolt 236 is passed through the first aperture 228 in the first clip segment 192 to be engaged with the first clip segment 192 and passed through the second aperture 232 in the second clip segment 196 to be engaged with the second clip segment 196. As the bolt 236 may enter into the nut 240 and be tightened with respect to the nut 240, the head portion 244 of the bolt 236 may come into abutment with the washer 256, and the washer 256 may apply a pre-load force against the bolt 236 (e.g., by biasing the head portion 244 of the bolt 236 and the first external surface 212 of the clip 184 away from each other) such that a loosening of the bolt 236 with respect to the clip 184 may be mitigated or altogether halted-such loosening may be otherwise possible both during such assembly and during operation when operational vibrations may be sustained by the coupler 180. Also, as the fastening system 188 may be actuated or as the bolt 236 may be tightened into the nut 240, a gap or the space, S, between the first clip segment 192 and the second clip segment 196 may be reduced in turn increasing a compression and contact between the first conductor 132 and the second conductor 136.

It may be noted that compared to surface areas of the fastening system 188 (e.g., surfaces areas of the head portion 244 and the nut 240 that may respectively come into contact with the first conductor 132 and the second conductor 136 had the clip 184 been absent), the first clip segment 192 and the second clip segment 196 define relatively larger corresponding surface areas for respectively contacting the first conductor 132 and the second conductor 136 and providing commensurate compression therebetween. Therefore, as the fastening system 188 may be actuated and the gap or the space, S, may be reduced, the portions (e.g., the first end portion 140 and the second end portion 144) may be urged or forced to impinge onto each other more effectively in comparison to a case where solely the fastening system 188 is used to attain the compression and electrical connection and thus an electrical contact area between the first conductor 132 and the second conductor 136—this may be particularly applicable in cases where one or more of the first conductor 132 and/or the second conductor 136 are relatively ductile (e.g., they may be made from copper) which may cause the head portion 244 and/or the nut 240 to simply be pushed into the bodies of the first conductor 132 and/or the second conductor 136, rather than achieving any commensurate increase or improvement in the compression of the first conductor 132 with the second conductor 136.

Usage of the coupler 180, therefore, increases the electrical contact area (see area 234 in FIG. 4 for reference) between the first conductor 132 and the second conductor 136 and enhances electrical conductivity at the electrical joint 148 or at the overlapped portions 160. Higher or improved electrical contact reduces electrical resistance at the electrical joint 148 or at the overlapped portions 160. Further, with the engagement feature 164 (or the protrusion 168) being engaged with the mating member 220 (or retained within the window 224) helps restrict the clip 184 from angular movement or rotation about the bolt axis 268 (e.g., during assembling or otherwise). Such restriction also reduces variations (e.g., an increase) in the clearance between the portions (e.g., the first end portion 140 and the second end portion 144) of the first conductor 132 and the second conductor 136, in turn also mitigating creepage at the electrical joint 148 or at the overlapped portions 160.

In some embodiments, the surface areas of the first internal surface 204 and the second internal surface 208 that comes respectively into contact with the portions (e.g., the first end portion 140 and the second end portion 144) of the first conductor 132 and the second conductor 136 may each be at least equal to or greater than a surface area of contact defined between the portions (e.g., the first end portion 140 and the second end portion 144) of the first conductor 132 and the second conductor 136 at the overlapped portions 160. In that manner, the first clip segment 192 and the second clip segment 196 may encompass (e.g., fully) the portions (e.g., the first end portion 140 and the second end portion 144) of the first conductor 132 and the second conductor 136 and may accordingly provide adequate electrical contact area between the overlapped portions 160. This results in enhanced or improved electrical contact between the first end portion 140 and the second end portion 144, e.g., upon the actuation of the fastening system 188 as described above.

Unless explicitly excluded, the use of the singular to describe a component, structure, or operation does not exclude the use of plural such components, structures, or operations or their equivalents. The use of the terms “a” and “an” and “the” and “at least one” or the term “one or more,” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B” or one or more of A and B″) is to be construed to mean one item selected from the listed items (A or B) or any combination of two or more of the listed items (A and B; A, A and B; A, B and B), unless otherwise indicated herein or clearly contradicted by context. Similarly, as used herein, the word “or” refers to any possible permutation of a set of items. For example, the phrase “A, B, or C” refers to at least one of A, B, C, or any combination thereof, such as any of: A; B; C; A and B; A and C; B and C; A, B, and C; or multiple of any item such as A and A; B, B, and C; A, A, B, C, and C; etc.

It will be apparent to those skilled in the art that various modifications and variations can be made to the method and/or system of the present disclosure without departing from the scope of the disclosure. Other embodiments will be apparent to those skilled in the art from consideration of the specification and practice of the method and/or system disclosed herein. It is intended that the specification and examples be considered as exemplary only, with a true scope of the disclosure being indicated by the following claims and their equivalent.

What is claimed is:

1. A coupler for electrically connecting a first conductor to a second conductor, the coupler comprising:
a clip defining a first clip segment and a second clip segment spaced apart from the first clip segment, the first clip segment and the second clip segment configured to respectively abut with the first conductor and the second conductor to accommodate overlapped portions of the first conductor and the second conductor therebetween; and
a fastening system engageable with the first clip segment and the second clip segment such that an actuation of the fastening system reduces a gap between the first clip segment and the second clip segment to increase a compression and contact between the first conductor and the second conductor, wherein,
compared to surface areas of the fastening system, the first clip segment and the second clip segment define relatively larger corresponding surface areas for respectively contacting the first conductor and the second conductor and providing commensurate compression therebetween.

2. The coupler of claim 1, wherein at least one of the first conductor and the second conductor defines an engagement feature and the clip defines a mating member to complimentarily engage with the engagement feature to restrict the clip within a range of motion with respect to the first conductor or the second conductor.

3. The coupler of claim 2, wherein
the engagement feature includes a protrusion extending from a body of the at least one of the first conductor and the second conductor, and
the mating member includes a window to, at least partly, receive the protrusion to enable the mating member to complimentarily engage with the engagement feature.

4. The coupler of claim 3, wherein
the clip includes a connector segment extending between the first clip segment and the second clip segment, and the window is formed in the connector segment, and
the first clip segment, the second clip segment, and the connector segment, are all integrally and contiguously formed.

5. The coupler of claim 1, wherein
the fastening system includes a bolt and a nut, the bolt passing through a first aperture in the first clip segment to be engaged with the first clip segment and through a second aperture in the second clip segment to be engaged with the second clip segment, and
the nut is fixedly fastened to the second clip segment and threadably coupled to a section of the bolt extending outwardly of the second clip segment to retain the bolt with the clip.

6. The coupler of claim 5, wherein the bolt is configured to be routed through the overlapped portions of the first conductor and the second conductor.

7. The coupler of claim 5, wherein the bolt includes a head portion and a shank portion, the coupler further including a washer positionable between the head portion and the clip, wherein the washer is configured to exert a force between the bolt and the clip to prevent a dislodgement of the bolt with respect to the clip,
wherein the washer includes a split washer.

8. The coupler of claim 5, wherein
the bolt defines a first outer surface configured to come in contact with the overlapped portions, the first outer surface including a primary material galvanically compatible with the overlapped portions to reduce corrosion of the overlapped portions and the bolt by reducing a potential between the overlapped portions and the bolt, and
the clip defines a second outer surface configured to come in contact with the overlapped portions, the second outer surface including a secondary material galvanically compatible with the overlapped portions to reduce corrosion of the overlapped portions and the clip by reducing a potential between the overlapped portions and the clip.

9. The coupler of claim 1, wherein one or more of the fastening system and the clip includes an insulation material to be non-conductive relative to one or more of the first conductor and the second conductor.

10. The coupler of claim 1, wherein at least one of the first conductor or the second conductor includes or corresponds to a copper busbar.

11. An electrical system, comprising:
a first electrical device and a second electrical device;
a first conductor operatively extending from the first electrical device and a second conductor operatively extending from the second electrical device; and
a coupler for electrically connecting the first conductor to the second conductor, the coupler including:
a clip defining a first clip segment and a second clip segment spaced apart from the first clip segment, the first clip segment and the second clip segment respectively abutted with the first conductor and the second conductor to accommodate overlapped portions of the first conductor and the second conductor therebetween; and
a fastening system engageable with the first clip segment and the second clip segment such that an actuation of the fastening system reduces a gap between the first clip segment and the second clip segment to increase a compression and contact between the first conductor and the second conductor, wherein,
compared to surface areas of the fastening system, the first clip segment and the second clip segment define relatively larger corresponding surface areas for respectively contacting the first conductor and the second conductor and providing commensurate compression therebetween.

12. The electrical system of claim 11, wherein at least one of the first conductor and the second conductor defines an engagement feature and the clip defines a mating member to complimentarily engage with the engagement feature to restrict the clip within a range of motion with respect to the first conductor or the second conductor.

13. The electrical system of claim 12, wherein
the engagement feature includes a protrusion extending from a body of the at least one of the first conductor and the second conductor, and
the mating member includes a window to, at least partly, receive the protrusion to enable the mating member to complimentarily engage with the engagement feature.

14. The electrical system of claim 13, wherein
the clip includes a connector segment extending between the first clip segment and the second clip segment, and the window is formed in the connector segment, and
the first clip segment, the second clip segment, and the connector segment, are all integrally and contiguously formed.

15. The electrical system of claim 11, wherein
the fastening system includes a bolt and a nut, the bolt passing through a first aperture in the first clip segment to be engaged with the first clip segment and through a second aperture in the second clip segment to be engaged with the second clip segment, and
the nut is fixedly fastened to the second clip segment and threadably coupled to a section of the bolt extending outwardly of the second clip segment to retain the bolt with the clip.

16. The electrical system of claim 15, wherein the bolt is configured to be routed through the overlapped portions of the first conductor and the second conductor.

17. The electrical system of claim 15, wherein the bolt includes a head portion and a shank portion, the coupler further including a washer positionable between the head portion and the clip, wherein the washer is configured to exert a force between the bolt and the clip to prevent a dislodgement of the bolt with respect to the clip,
wherein the washer includes a split washer.

18. The electrical system of claim 15, wherein
the bolt defines a first outer surface configured to come in contact with the overlapped portions, the first outer surface including a primary material galvanically compatible with the overlapped portions to reduce corrosion of the overlapped portions and the bolt by reducing a potential between the overlapped portions and the bolt, and
the clip defines a second outer surface configured to come in contact with the overlapped portions, the second outer surface including a secondary material galvanically compatible with the overlapped portions to reduce corrosion of the overlapped portions and the clip by reducing a potential between the overlapped portions and the clip.

19. The electrical system of claim 11, wherein one or more of the fastening system and the clip includes an insulation material to be non-conductive relative to one or more of the first conductor and the second conductor.

20. The electrical system of claim 11, wherein at least one of the first conductor or the second conductor includes or corresponds to a copper busbar.
